(19) United States
(12) Patent Application Publication
(10) Pub. No.: US 2016/0079795 A1
(43) Pub. Date: Mar. 17, 2016

(54) MODULAR POWER GENERATION AND ENERGY STORAGE DEVICES

(71) Applicant: Romeo Systems, Inc., San Francisco, CA (US)

(72) Inventors: Michael William Patterson, Pacific Palisades, CA (US); Benjamin Philip Diaz Cannon, San Francisco, CA (US); Anastasi William Michailidis, San Francisco, CA (US)

(21) Appl. No.: 14/720,402

(22) Filed: May 22, 2015

Related U.S. Application Data
(60) Provisional application No. 62/002,061, filed on May 22, 2014.

(51) Int. Cl. H02J 7/02; H02J 7/00; H01M 10/44; H02J 7/04

(52) U.S. Cl. CPC H02J 7/025; H02J 7/04; H02J 7/0042; H01M 10/441

(57) ABSTRACT

The present disclosure provides systems for storing electrical energy. A system for storing energy comprises a plurality of separable energy storage devices that are operatively connected in series or parallel. Each energy storage device of the plurality comprises a housing that includes a magnet that generates a magnetic field, an armature coil that rotates relative to the magnetic field upon user movement of the housing or the armature coil, and an energy storage unit electrically coupled to the armature coil and adapted to store electrical energy generated upon rotation of the armature coil in the magnetic field.

### CROSS-REFERENCE

This application claims priority to U.S. Provisional Patent Application Ser. No. 62/002,061 filed May 22, 2014, which is entirely incorporated herein by reference.

### BACKGROUND

An electric battery is a device having of one or more electrochemical cells that convert stored chemical energy into electrical energy. Each cell contains a positive terminal, or cathode, and a negative terminal, or anode.

Electric batteries can be rechargeable. In some cases, a power source can be used to provide power to charge a rechargeable electric battery.

Electric batteries can be used to deliver power to a load, such as an electronic device that operates upon the flow of electrical current (e.g., television, mobile computer, etc.) or power inverter or converter to drive same. One or more electric batteries can be a part of an energy storage system that can store energy for future use.

### SUMMARY

The present disclosure provides devices and systems that can include multiple mechanical and electrical components that can be used to harness kinetic energy to generate power, store energy, combine energy systems, meter power, convert power, and deliver power. Such systems can be modular. A modular energy device can harvest energy from any kinetic or thermal energy source to store, combine and/or release energy (power) for small or large personal or commercial uses.

In an aspect of the disclosure, a system for storing energy and generating electrical power can comprise a plurality of separable energy storage and power generation devices that are operatively connected in series or parallel, wherein each energy storage device of the plurality comprises a housing that includes: a magnetic member that provides a magnetic field; an armature coil that rotates relative to the magnetic field upon movement of the housing or the armature coil; and an energy storage unit electrically coupled to the armature coil and adapted to store electrical energy generated upon rotation of the armature coil in the magnetic field.

In another aspect of the disclosure, an energy storage device including a portable housing can comprise a magnetic member that provides a magnetic field; an armature coil that rotates relative to the magnetic field upon movement of the portable housing or the armature coil; a plurality of gears coupled to the armature coil, wherein each gear of the plurality effects a different frequency of rotation of the armature coil in the magnetic field; and an energy storage unit electrically coupled to the armature coil and adapted to store electrical power generated upon rotation of the armature coil relative to the magnetic field.

In another aspect of the disclosure, a method of storing energy and generating electrical power can comprise connecting two or more separable energy storage and power generation devices in series or parallel such that the two or more devices are in electrical and mechanical communication with each other, wherein each of the two or more separable energy storage and power generation devices comprises a housing containing (i) a magnetic member that provides a magnetic field, (ii) an armature coil that rotates relative to the magnetic field upon movement of the housing or the armature coil, and (iii) an energy storage unit electrically coupled to the armature coil and adapted to store electrical energy generated upon rotation of the armature coil in the magnetic field; subjecting the armature coil to motion relative to the magnetic field, thereby generating electrical current; and transmitting the electrical current to the energy storage unit.

Energy storage devices of the present disclosure can be modular for energy conversion and storage. In some cases, an energy storage device can generate an induced, inductive, or reactive current from a thermal or kinetic energy source. The generated current may be used to provide power to an outside load or to store charge in an on-board energy storage device. The energy storage device can be configured to permit a user to generate the current. The user can generate the current by providing kinetic energy to the energy storage device. In some cases, the user can connect the device to a system that generates kinetic energy to capture and/or store at least a fraction of the kinetic energy with the device. The inductive current can be generated by any movement of a conductive material in a magnetic field that can cause an induced current, for example by rotation of an armature coil in a magnetic field. A barter or trade system may arise in which individuals may charge energy storage devices and provide fully charged devices to other individuals in exchange for goods, services, or currency.

In some cases, a plurality of devices may be stacked or connected to increase their power output to provide power to a variety of loads with different and/or variable power requirements. The devices may stack together separably to increase the available power. The power/current output from the devices may be metered by an onboard or off-board processor (or other logic) or converter circuitry. The devices may be metered such that power may be drawn down or stored evenly across multiple devices when devices are connected.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a schematic of electrical and mechanical components used in a modular energy storage device.

FIG. 2 is an example of a device housing.

FIG. 3 is a cross sectional view of a modular energy storage device showing connections between armatures and ports.

FIG. 4a is a top view of a port (socket).

FIG. 4b is a side view of a male connection port.

FIG. 4c is a side view of a female connection port.

FIG. 4d is a side view of an example of a port-to-port connection.

FIG. 5 shows examples of gear ratios showing driven and driver gears and gear trains.

FIG. 6 is an example of a ball port connection.

FIG. 7 is an example of an ensemble of stacked modular devices connected in series to power and external load.

FIG. 8 is an example of a user interface switch to operate a device in “charge”, “power”, or “share” mode.

FIG. 9 shows an example of a device embodiment with a CPU controller connected in series with an energy storage device.

FIG. 10 is an example of a user interface for metering charge remaining in an energy storage device.

FIG. 11 is an example of a device housing a cluster of 9 devices.

FIG. 12 is an example of a mobile operating system user interface integrated with a modular energy storage device or an ensemble of modular devices.

FIG. 13 shows a motor generator assembly.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The present disclosure provides power generation and storage systems that include one or more modular power generation and energy storage devices. A modular power generation and energy storage device can include one or more magnetic field sources (e.g., permanent or electromagnet) and circuitry for inductively generating electricity using the one or more magnetic field sources. The circuitry can be in electrical communication or contact with one or more energy storage units (e.g., rechargeable batteries) for storing electrical energy upon generation of electricity.

The present disclosure provides a system for generating and storing electrical energy using a modular energy storage device. The energy storage device can include a variety of mechanical and electrical components used to harness kinetic and/or geothermal energy using induced electrical current (“current”). The modular energy storage device may complete all or one of the tasks of generating electrical energy, storing energy, delivering power, or metering delivered power. The energy storage device may harvest kinetic energy and store energy from any source that moves, such as a user (e.g., human, animal, or machine, wind, or water). The stored energy can be used to provide power to an electronic device (e.g., mobile electronic device), for example a cellular phone, tablet, laptop computer, or other small electronic device. Furthermore, the modular stored energy device may be connected or stacked with a plurality of devices to provide power to larger electronic devices such as electric vehicles, commercial buildings, or residential buildings.

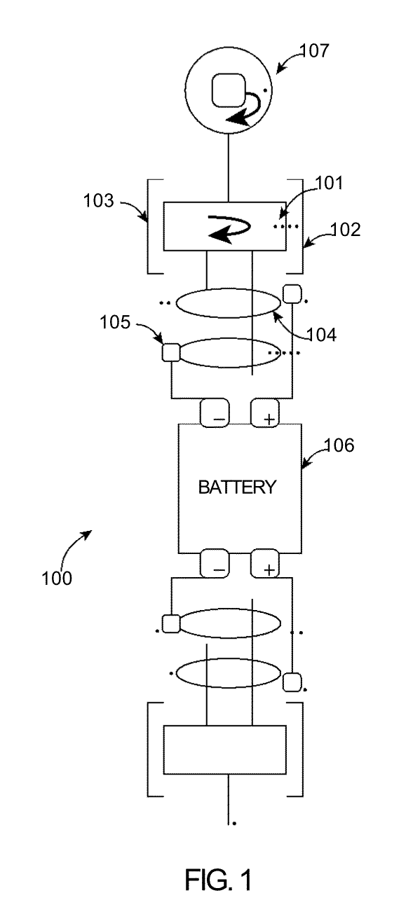

FIG. 1 shows a schematic 100 of the mechanical and electrical components in a modular power generation and energy storage device. The energy storage device contains an armature 101 situated between north 102 and south 103 poles of a magnet. The storage device can contain an armature arranged in a magnetic field provided in the device. The armature may comprise a metal core wound with a conductive wire; the ends of the conductive wire may each be attached to a conductive slip ring 104. Alternatively, the magnet and armature may be reversed in a “brush-less” configuration (not shown). The slip rings, if any, may be in electrical contact with conductive brushes 105. The conductive brushes 105, if any, may be in electrical contact with an energy storage device 106. The mechanical and electrical components may be enclosed in a container (not shown). Current may be generated by rotation of the armature 101 in the magnetic field created by the north 102 and south 103 magnetic poles. A mechanical socket (mechanical port) 107 can be provided to rotate the armature from outside of the container. The device can have two or more mechanical sockets. The mechanical port may be mechanically connected interiorly to the armature by a rod. The mechanical port can permit transmit movement from the port to the armature coil. The mechanical port can cause movement of the armature inside of the device by a user or system that is moving outside of the device.

There may be various approaches for rotating an armature coil or permanent magnet. The armature coil or permanent magnet can be coupled to a moving part. The armature coil or permanent magnet can be coupled to a moving part directly or through the mechanical port. For example, a user may rotate the armature coil to generate electrical energy (or electricity). As another example, the armature coil can be directly or indirectly mechanically coupled to a moving part, such as a wheel or tire (e.g., bike tire or car tire). The mechanical coupling can be provided by the mechanical port. As another example, the armature coil can be mechanically coupled to fitness equipment, an engine shaft, rotating playground equipment, a hydraulic or wind turbine, a moving animal, or a system that produces vibration (e.g., laundry machine, vehicle on uneven road surface, or earth seismic activity).

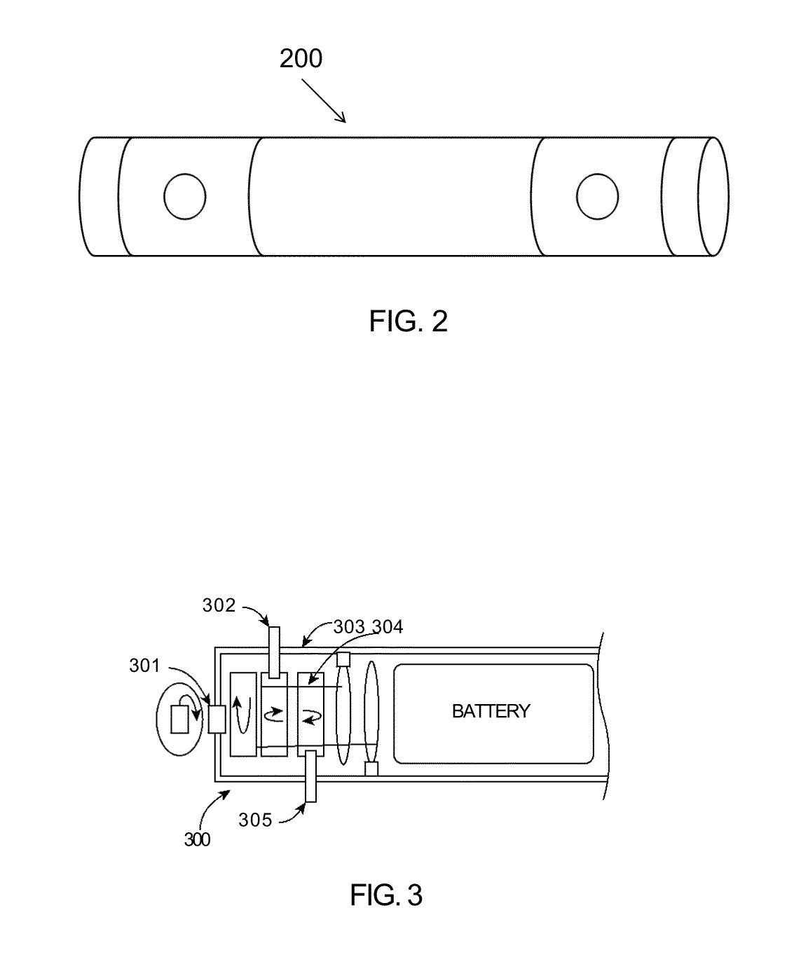

The modular charging device may be enclosed in a container or housing. The device housing may be rugged, durable, and shock resistant, heat resistant, or water resistant. The device housing can be formed from of at least one of the following: a metallic material (e.g. aluminum, titanium, or stainless steel), a composite material (e.g. carbon fiber), or a polymeric material (e.g. plastic, EPDM, or rubber). The device housing can have The housing of the device can have a cross-section of various shapes, such as circular, elliptical triangular, square, rectangular, pentagonal, or hexagonal, or partial shapes or combinations thereof. The housing of the device can have various shapes, such as spherical, cylindrical or box-like, or partial shapes or combinations thereof. FIG. 2 shows a cylindrical device housing 200 with a length of about 10 inches and a diameter of about 2 inches.

The device may have weight and dimensions such that an individual device is portable. For example, a housing of the device may have a length of at least 1 inch (in), 2 in, 3 in, 4 in, 5 in, 10 in, 20 in, or 30 in. The housing of the device may have a cross-section of at least about 1 in, 2 in, 3 in, 4 in, 5 in, 6 in, or 12 in. The device may have a weight of at least about 0.5 pounds (lb), 1 lb, 2 lb, 3 lb, 5 lb, 10 lb, 15 lb, or 20 lb.

The device housing may contain a magnet. The magnet may be a permanent magnet. The permanent magnet may be any variety of rare earth magnet, for example sintered NdFeB, bonded NdFeB, SmCo, AlNiCo, or Ferrite. The magnet may be an electromagnet. The magnet may line the entire interior of the housing. Alternatively, the magnet may be the portion of the device that is in rotation, and in such a configuration an armature will be stationarily bonded to the housing around it. In some cases, the magnet may be confined to a region of the interior of the housing.

The device may contain a generator for converting mechanical energy into electrical energy. The generator may comprise one or all of the following; an armature coil, a magnet, a brush, and a slip ring. An armature coil may comprise a metal core wound with a conductive wire. The metal core may be iron or steel, for example. In certain configurations, it may be eliminated entirely and a self-supporting winding substituted. The conductive wire may be copper, aluminum, silver, or gold, for example. The armature may be U-shaped, ring-shaped, disk-shaped, or another shape. The armature coil may be arranged between a north pole and a south pole of a magnet, such that the armature coil is in the path lines of a magnetic field within the device. The armature coil may be able to rotate normal (perpendicular) to the magnetic field. Rotation of the armature coil in the magnetic field may generate a current in the armature wire winding. The armature coil may be rotated inside of the device housing by an energy source outside of the housing. Alternatively, the magnet may be the portion of the device which is rotated, in which case the armature winding shall enclose the magnetic core and directly provide electric current without a slip ring or brush, in a “brushless” configuration.

In some cases, the current generated in the armature wire may be collected by a set of slip rings, if AC (alternating current) current is the desired or given output, or by a commutator if DC (direct current) current is the desired output. Slip rings may be electrically conductive rings in electrical connection with either end of the armature wire winding. The rings may be made of any electrically conductive material, for example copper, silver, gold, or aluminum. The slip rings may transfer the current generated by the armature rotation to one or more brushes. Each slip ring may be in contact with at least one brush. The brush may be stationary strips, bristles, or wires of a conductive material, for example copper, silver, gold, or aluminum. The brushes may be in electrical connection with one or more energy storage devices, for example a battery, fuel cell, or capacitor. The energy storage device may be a rechargeable battery. In some cases, the energy storage device may comprise a plurality of batteries in discreet power units, communicating with one another, to power a shared load.

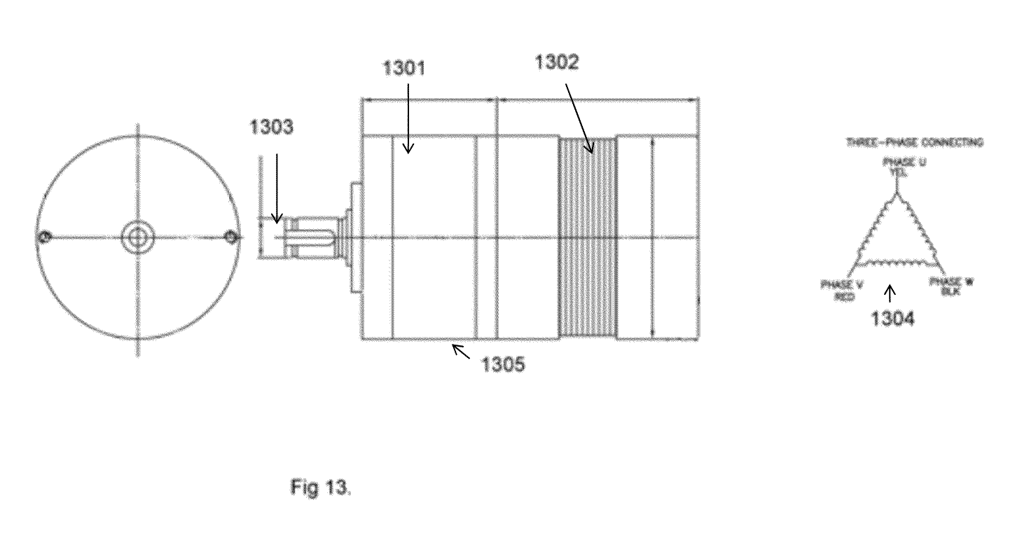

In some cases, the device can comprise a motor generator assembly as show in FIG. 13 shows a diagram of the electromechanical components of a modular power generation device. The device contains a motor-generator assembly 1302 that can be either brushed (described elsewhere) or brushless 1304, a gear reduction set 1301 that can be either standard or planetary in nature, and a motive input shaft 1303 that can be splined, keyed, plain, quick-attach, or another configuration. The mechanical or electrical components may be encased in a case 1305.

The device may comprise at least 1, 2, 3, 4, 5, 6, 7, 8, 9, 10, 15, or 20 connection ports. Connection ports can be mechanical ports. Connection ports can be electrical ports. Electrical ports can provide electrical communication between a device and a load and/or between a device and another device. Ports may be both inputs and outputs and may be activated (e.g., moved or rotated) to actuate the generator inside of the device housing. The ports may have various shapes, such as circular, square, rectangular, or hexagonal. The amount of current generated by rotation of the armature by movement at one of the ports may be proportional to a rotation speed of the armature. FIG. 3 shows a partial cross section of a complete modular energy storage device 300. The device 300 can have a total of three ports, two or more of the ports can be electrical ports 302 and 305 and one or more of the ports can be a mechanical port 301. Each mechanical port 301 can be connected inside the housing 303 to an armature coil 304. Outside of the housing the port protrudes from the housing. The protrusion of any port outside of the housing may connect with an adjacent device when the devices are stacked or otherwise disposed in a modular configuration, or with an adapter to transmit kinetic energy, such as a crank or an attachment to a bicycle wheel. In some cases, a first mechanical port coupled to a first armature coil of a first device and a second mechanical port coupled to a second armature coil of a second device can be mechanically connected. The first mechanical port can be separably coupled to the second mechanical port such that movement of at least one of the first device and the device induces motion in the first armature coil and the second armature coil relative to a magnetic member of a respective one of the first separable energy storage and power generation device and second separable energy storage and power generation device.

The port may protrude from the device housing at least about ⅛″, ¼″, ½″, ¾″, 1″, 1.5″, 2″, 2.5″, 3″, 3.5″, 4″, 4.5″, or 5″. Connection ports may have male or female connections. Ports may be used to and stack the modular devices such that they may be in connection mechanically and/or electronically. Devices may be connected in series or parallel. The ports may output AC or DC current. Devices may or may not include a battery.

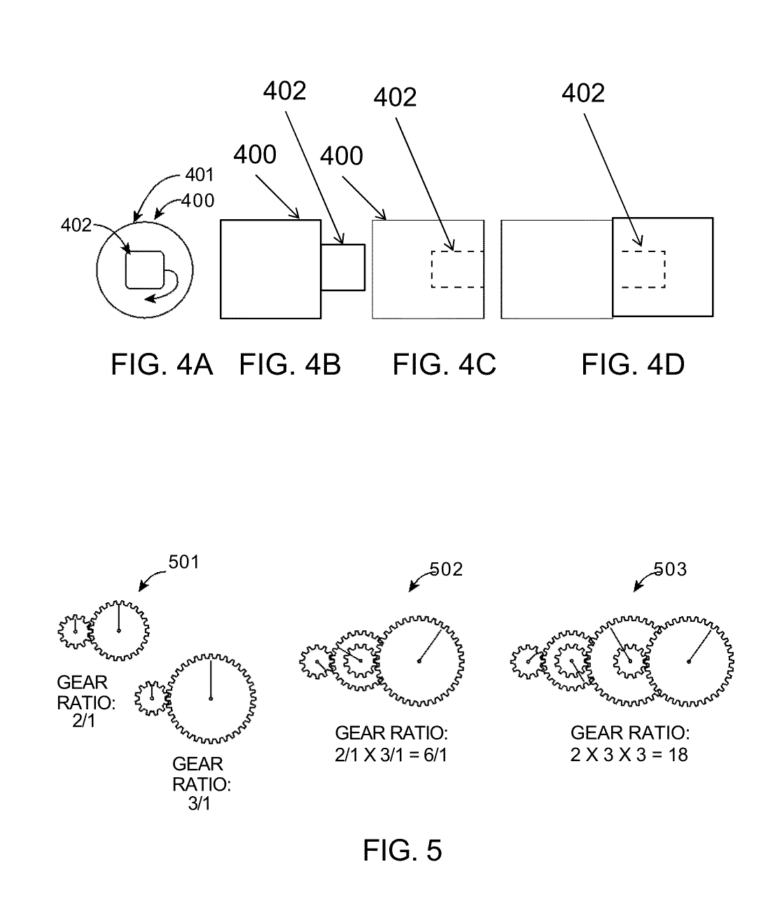

FIG. 4a shows a top view of a device with a port 400. The port can be a mechanical port or an electrical port. The port 400 can have two components, an outer ring 401 and a square region 402. The square region is designed to mate with an adjacent device when the devices are stacked or with an adapter to transmit kinetic energy, such as a crank or an attachment to a bicycle wheel. The square region can be a protrusion or an indentation. The square region can comprise an electrical contact. The square region may be part of a male or female connection. The square region can be a male connection, a female connection, or both. If the port is a male connection the square region can be an extruding peg (FIG. 4b, side view), and if the port is a female connection, the square region can be a recessed cavity (FIG. 4c, side view). When devices are stacked, the ports on a first device and a second device may connect, such as, for example, in the manner shown in FIG. 4d, which shows male and female ports mated to one another.

Connection ports may be used to direct movements from a kinetic energy source outside of a device to an armature coil or a magnet inside of the device. For example a kinetic energy source may be a rotating wheel, a flywheel, a flowing fluid, or a human turning a crank arm. Mechanical ports may connect to an armature inside of the device housing via a rod so that activation (rotation) of the external port results in an internal rotation of the armature coil, hence generating current. Similarly, in cases where the armature coil is stationary, the mechanical ports may connect to one or more magnets inside of the device housing via a rod so that activation (rotation) of the external port results in an internal rotation of the one or more magnets, hence generating current Ports may rotate in a clockwise or counter-clockwise direction. Ports may be able to accept connections to kinetic energy sources, for example a port may mate with a crank arm attachment so that a human can turn the crank arm to rotate the ports, thereby rotating the armature and generating current. In another case a port may attach to a wheel so that when the wheel rotates the port is also rotated and therefore the armature may rotate to generate current. Generated current may be stored in the device in an energy storage unit, such as a battery (e.g., rechargeable battery) or a capacitor.

The mechanical port may be mechanically connected to the armature and/or one or more magnets inside of the housing through a gear system. They gear system may comprise a driven gear connected to the port and a driver gear connected to the armature. The gear system may be used to provide a range of torque and revolutions per minute (RPM) parameters compatible with the motive source and armature parameters to optimally generate current with the device.

Ports connected to an armature with a low gear ratio may be relatively easy (e.g., requiring less torque) to turn and thus more suited to lower torque but higher speed sources of motive force. Ports connected to an armature with a high gear ratio may be relatively difficult (requiring more torque) to turn. Gear ratio may be defined as the ratio of the angular velocity of the driver gear to the angular velocity of the driven gear. FIG. 5 shows example gear ratios that may be embodied by the device 501. Examples of probable gear ratios may be 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, or similar, up to at least 100:1. Furthermore the rotation direction of the armature may be controlled using a gear train, for example a gear train may be configured such that a clockwise rotation of the port causes a counter-clockwise rotation of the armature. FIG. 5 shows an embodiment of a gear train that may be used to cause rotation of the driven gear opposite of the driver gear 502 or 503. Finally, the gears may be arranged in a spline, or planetary, or other, arrangement, as appropriate.

Each electrical port may be able to act as a conductor of current. Each electrical port can have one or more electrical contacts. The current output by the port may come from the energy storage device inside of the housing. A single modular energy storage device may be used to provide power to a device. A port may be able to attach electronically to a USB, mini USB, micro USB, USB Type-C, 2-prong cord, 3-prong cord, proprietary connector, or socket cord to power a device. Furthermore a modular energy storage device may be connected or stacked with another modular energy storage device. When multiple devices are connected they may be able to deliver more kilowatts of power for larger consumption needs.

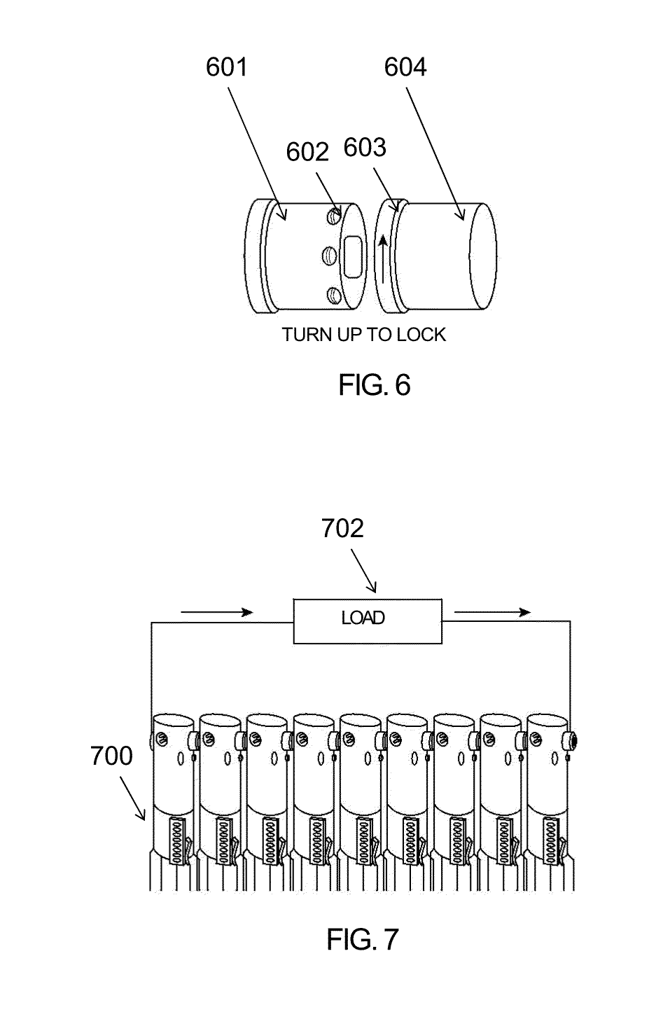

Devices may be connected and locked to together. Locking or connecting one device to another device can bring the devices in electrical communication with one another. The devices may be temporarily locked together, for example, by mating of a threaded connection, a pin connection, a snap connection, or a balled connector. FIG. 6 shows an example approach that can be used to temporarily connect adjacent modular energy storage devices. A first port 601 shown in FIG. 6 has a balled connector 602 on a surface of the port and has a recessed lip that is manually raised up and turned to lock. The balled connector can be fitted into a groove 603 of a second port 604 to provide a mechanical and/or electrical connection between a first and second port. When the lock is thrown, the socket to socket connection may result in a closed circuit between the adjoined modular devices. Many devices may be connected together, for example at least about 2, 3, 4, 5, 10, 20, 30, 40, 50, 100, 200, 300, 400, 500, or 1000 modular devices may be connected. A single device may be able to provide at least 50 Watts (W) of power, when devices are connected a total assembly of devices may be able to provide power on the order of at least about 50 W, 100 W, 500 W, 1 kilowatt (kW), 2 kW, 3 kW, 4 kW, 5 kW, 10 kW, 50 kW, 100 kW, 200 kW, 300 kW, 400 kW, 500 kW, or 1 megawatt (MW).

FIG. 7 shows an example of nine devices 700 that are connected to one another in series and in electrical communication providing power to a load 702. Alternatively, devices may be connected in parallel. The load may be, for example, a vehicle, a computer server, a commercial building, a residential building, a large appliance, a well pump, or a power distribution facility. If each of the devices shown in FIG. 7 holds 12,000 milliamp hour (mAh), then the total capacity of the ensemble is 108,000 mAh. For an energy storage device generally, the higher the mAh, the longer the energy storage device can be able to provide current. Energy storage devices with different mAh ratings are interchangeable. If an energy storage device is rechargeable then the mAh rating is how long the energy storage device can provide current per charge.

A cluster of connected devices may be enclosed in a cluster housing (or container). The cluster housing may be sized to hold a given or predetermined number of devices, or the housing may be adjustable to fit a variable number of devices. In some instances, the cluster housing may be formed of one or more of the following: a metallic material (e.g. aluminum, titanium, or stainless steel), a composite material (e.g. carbon fiber), and a polymeric material (e.g. plastic, EPDM, or rubber). The cluster housing can have a cross-section of various shapes, such as circular, elliptical triangular, square, rectangular, pentagonal, or hexagonal, or partial shapes or combinations thereof. The cluster housing may be in electrical communication with the clustered devices. The cluster housing can hold at least 1, 2, 3, 4, 5, 6, 7, 8, 9, 10, 20, 30, 40, 50, 60, 70, 80, 90, 100, 200, 300, 400, 500, 1000, or 10,000 devices of the present disclosure. The cluster housing may have a current inlet and outlet for a load attachment to access energy stored in the cluster, as well as cooling input/outputs.

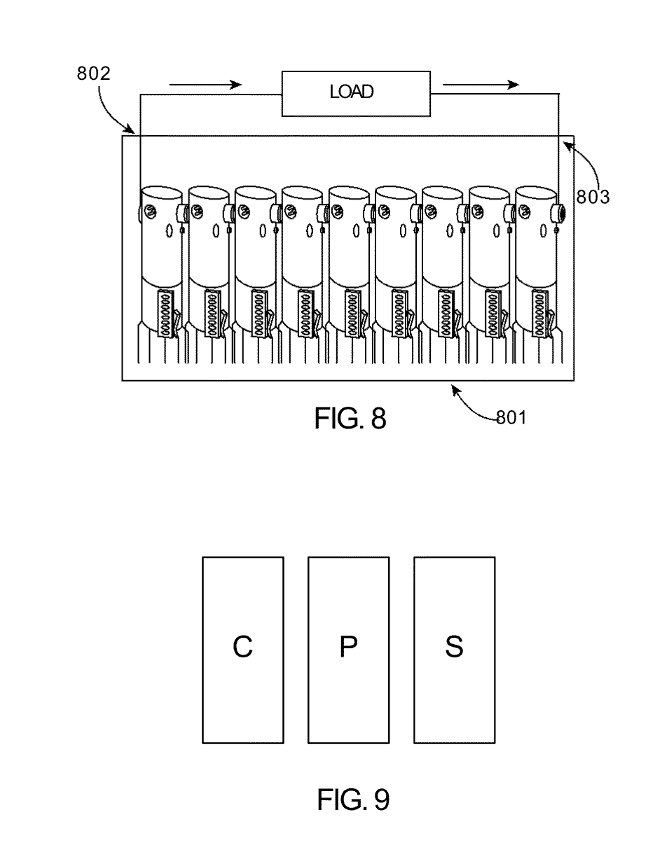

An example of a cluster housing is shown in FIG. 8. The cluster housing 801 holds 9 devices. The housing 801 has a load attached to an integrated current inlet 802 and outlet 803 which are connected electrically to the device cluster inside of the housing.

The modular energy storage device may have three basic modes of operation. A “charge” mode is engaged when the device is being used to harvest kinetic energy by turning the armature coil to store energy in the energy storage device. A “power” mode is engaged when energy is drained from the storage device to provide power to an exterior load. A “share” mode can be chosen when the devices are stacked into an energy storage system to in series, parallel, or a combination of series and parallel. In some configurations, “power” and “share” mode may be automatically selected by an onboard or outboard processing unit or converter board, based on inter-device communication or sensed parameters.

In some cases, an energy storage device may comprise an exterior switch to toggle between these modes of operation. FIG. 9 shows an example user interface for use in switching the operation modes. This switch interface has three button labeled C, P, and S corresponding to modes of charging (C), power (P), and sharing (S), respectively. As an alternative, the energy storage device can include circuitry that can automatically set the operational mode of the device. The circuitry can include a computer processor or other logic, in addition to memory for storing a software implemented algorithm that directs the mode of operation of the device.

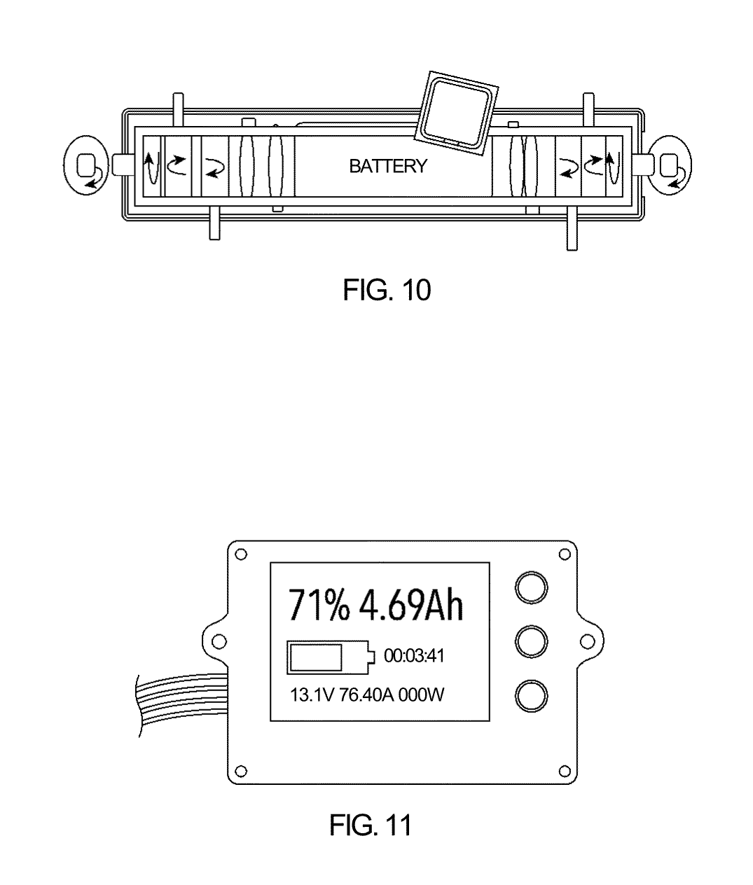

In power and sharing modes, current can be electrically routed from an energy storage device to an adjacent device and eventually to a load (sharing) or directly to a load. The current path of each device can be connected to the energy storage device and may be managed by a CPU or micro-controller, which may be activated by a switch or user interface (UI). The micro-controller may control the release and metering of power from the energy storage device. In an example, the device may utilize a micro-controller (e.g., a tiny wafer of semiconducting material used to make an integrated circuit) that contains a central processing unit (CPU). When devices are stacked, the CPU may accept digital input from connected devices and processes the data as instructed for the release and metering of the current. The CPU may also measure and indicates the remaining charge and power available from the energy storage device. The CPU, or associated sensors, may be in series with the conductor path of the energy storage device. FIG. 10 shows a device with a microchip in series with the conductor path of the energy storage device.

The CPU may regulate the release of power from the energy storage device using a smart meter. The smart meter may regulate power release autonomously or in response to a user input. The smart meter may include a user interface to communicate the remaining charge available in an energy storage device when the device is in “power” or “share” operation mode. Alternatively, in “charge” mode the smart meter user interface may communicate how close the energy storage device is to achieving full charge so that a user may determine how much more kinetic energy needs to be harvested. An example of a user interface (UI) for a smart meter is shown in FIG. 11. The user interface can include light emitting diodes (LEDs) to show various stages of charge and operation of the device. In the UI shown in FIG. 11 the total charge remaining in the energy storage device is shown in increments of 10% from 0% charge to 100% charge. When multiple devices are connected the user interface may designate one device in a series of stacked devices the “master” device. The user interface on the master device may display the power available from all the connected devices.

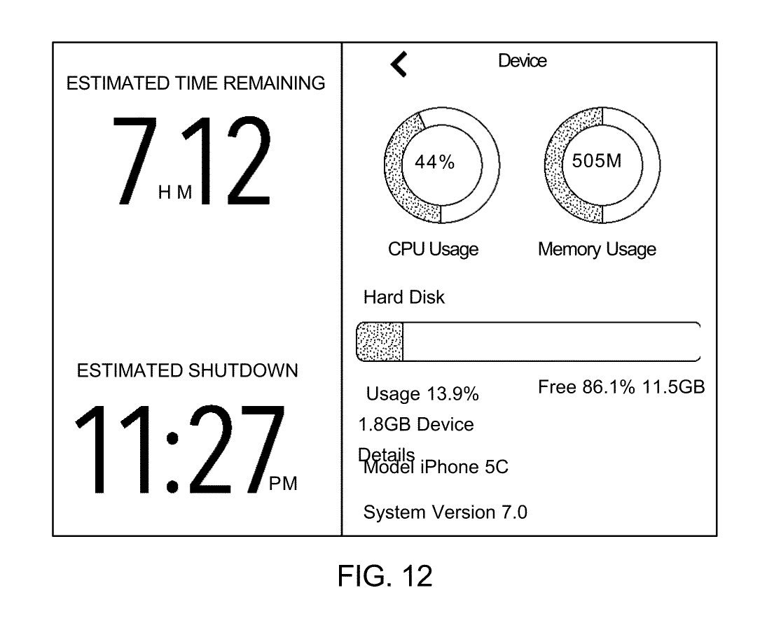

A modular energy storage device may also utilize a mobile operating system for advanced connectivity and operation. Simple UI's can display a wide range of power consumption efficiencies. Advanced options include entire operating systems for modular energy device specific application development. Specific application may include without limitation; crowdsourcing platforms to locate nearby sources of kinetic energy for harvesting to recharge the modular device, estimated range (if devices are being used power a vehicle) or time remaining on current charge capacity, and audible or visual alerts to notify the user when device power is near depleted. FIG. 12 depicts an example user interface of a mobile operating system. The user interface can be displayed on a modular energy storage device of the present disclosure or on an electronic display of an electronic device of a user. The interface displays time remaining and CPU usage. The interface or components thereof, may communicate with an App (e.g. android or iOS or similar) on a smartphone and/or with the web or cloud computing servers.

Modular energy storage devices of the present disclosure can include communications interfaces for bringing the energy storage devices in communication with external electronic devices, such as a mobile electronic device of a user. This can enable the user to communicate with a module electronic device, such as to determine a level of charge of the device or a power output of the device, and/or to determine whether the device is functioning properly. A communications interface can be wired or wireless. Examples of wireless communications interfaces include WiFi and Bluetooth, BLE 4.0, MNO, Wireless cell, GPRS, UMTS, GSM.

### Example 1

A user has two modular energy storage devices, each being as shown in FIG. 1. Each device has a rotatable armature, magnetic field source (e.g., magnet) and possibly a rechargeable battery. The user induces rotation of the armature in a magnetic field provided by the magnetic field source. This produces electrical energy that is stored in the rechargeable battery. The user then electrically couples the two modular energy storage devices in series to provide an energy storage system. The user then electrically connects the energy storage system to a mobile electronic device (e.g., Smart phone or laptop) to charge the mobile electronic device.

### Example 2

A first user has access to at least one modular energy storage device, such as the device of FIG. 1. The device has a rotatable armature, magnetic field source (e.g., magnet) and possibly a rechargeable battery. The first user induces rotation of the armature, which rotates in a magnetic field provided by the magnetic field source. This produces electrical energy that is stored in the rechargeable battery, to provide a charged device. A second user then takes the charged device from the first user in exchange for currency, goods, or services to the first user. The second user then uses the charged device to provide power to an electronic device (e.g., computer system or mobile electronic device) of the second user.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A system for storing energy and generating electrical power, comprising:
a plurality of separable energy storage and power generation devices that are operatively connected in series or parallel, wherein each energy storage device of the plurality comprises a housing that includes:
(a) a magnetic member that provides a magnetic field;
(b) an armature coil that rotates relative to the magnetic field upon movement of the housing or the armature coil; and
(c) an energy storage unit electrically coupled to the armature coil and adapted to store electrical energy generated upon rotation of the armature coil in the magnetic field.

2. The system of claim 1, wherein the magnetic member is an electromagnet that generates a magnetic field.

3. The system of claim 1, wherein the energy storage unit is a battery.

4. The system of claim 1, wherein the armature coil is mechanically coupled to a at least one port the through an exterior portion of the housing such that movement of the at least one port is transmitted through the at least one port to the armature coil to subject the armature coil to relative motion.

5. The system of claim 1, wherein the housing further comprises two or more electrical ports configured to provide connectivity between two or more of the separable energy storage and power generation devices in the plurality.

6. The system of claim 5, wherein the connectivity permits electrical communication.

7. The system of claim 1, wherein the plurality of separable energy storage and power generation devices comprises a first separable energy storage and power generation device and a second separable energy storage and power generation device, wherein the first separable energy storage and power generation device comprises a first port coupled to a first armature coil and the second separable energy storage and power generation device comprises a second port coupled to a second armature coil, wherein the first port is separably coupled to the second port such that movement of at least one of the first separable energy storage and power generation device and second separable energy storage and power generation device induces motion in the first armature coil and the second armature coil relative to a magnetic member of a respective one of the first separable energy storage and power generation device and second separable energy storage and power generation device.

8. An energy storage device including a portable housing, comprising:
(a) a magnetic member that provides a magnetic field;
(b) an armature coil that rotates relative to the magnetic field upon movement of the portable housing or the armature coil;
(c) a plurality of gears coupled to the armature coil, wherein each gear of the plurality effects a different frequency of rotation of the armature coil in the magnetic field; and
(d) an energy storage unit electrically coupled to the armature coil and adapted to store electrical power generated upon rotation of the armature coil relative to the magnetic field.

9. The device of claim 8, wherein the energy storage unit is a battery.

10. The device of claim 8, wherein the energy storage device is detachable from the device.

11. The device of claim 8, wherein the armature coil is mechanically coupled to at least one port through an exterior portion of the housing such that movement of the at least one port is transmitted through the at least one port to the armature coil to subject the armature coil to relative motion.

12. The device of claim 11, wherein the at least one port is mechanically coupled to a source of kinetic energy.

13. The device of claim 8, wherein the housing further comprises two or more electrical ports configured to provide electrical connectivity to two or more energy storage devices.

14. The device of claim 13, wherein at least one of the two or more electrical ports is configured to connect to an electrical load to provide power transmission from the device to the electrical load, or vice versa.

15. The device of claim 8, wherein a given gear in the plurality of gears is selectable by a user of the device.

16. A method of storing energy and generating electrical power, comprising:
connecting two or more separable energy storage and power generation devices in series or parallel such that the two or more devices are in electrical and mechanical communication with each other, wherein each of the two or more separable energy storage and power generation devices comprises a housing containing (i) a magnetic member that provides a magnetic field, (ii) an armature coil that rotates relative to the magnetic field upon movement of the housing or the armature coil, and (iii) an energy storage unit electrically coupled to the armature coil and adapted to store electrical energy generated upon rotation of the armature coil in the magnetic field;
subjecting the armature coil to motion relative to the magnetic field, thereby generating electrical current; and
transmitting the electrical current to the energy storage unit.

17. The method of claim 16 further comprising using the energy storage unit to provide power to an electrical load.

18. The device of claim 16, wherein the armature coil is mechanically coupled to at least one port through an exterior portion of the housing such that movement of the at least one port is transmitted through the at least one port to the armature coil to subject the armature coil to relative motion.

19. The device of claim 19, wherein the at least one port is mechanically coupled to a source of kinetic energy.

20. The device of claim 16, wherein the energy storage unit is comprised of a plurality of batteries in discreet power units, communicating with one another, to power a shared load.
